(19) United States
(12) Patent Application Publication
(10) Pub. No.: US 2008/0026820 A1
(43) Pub. Date: Jan. 31, 2008

(54) Slot machine and playing method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/582,418

(22) Filed: Oct. 18, 2006

Related U.S. Application Data
(60) Provisional application No. 60/818,317, filed on Jul. 5, 2006.

(51) Int. Cl. A63F 13/00

(52) U.S. Cl. 463/20

(57) ABSTRACT

A slot machine executes either a base game or a stop control game. The stop control game is constituted by plural stop control unit games. In the stop control unit game, symbols come to a stop on a payline in accordance with a stop operation by a player. When executing the stop control game, the slot machine varies the number of coins to be paid out to the player and a stock rate in accordance with the number of times of the stop control unit game in which a specific combination did not come to a stop on the payline.

### CROSS-REFERENCE TO RELATED APPLICATION

This application is based upon and claims the benefit of U.S. Provisional Patent Application Ser. No. 60/818,317, filed on Jul. 5, 2006; the entire contents of which are incorporated herein by reference for all purposes.

### BACKGROUND OF THE INVENTION

1. Field of the Invention

The present invention relates to a slot machine for playing a game using game media such as coins and bills and a playing method thereof.

2. Description of Related Art

As disclosed in U.S. Pat. No. 6,960,133B1 or U.S. Pat. No. 6,012,983, in a conventional slot machine, when a player inserts game media such as medals, coins, and bills into the slot of the slot machine and presses a spin button, plural symbols are scrolled on a display unit provided on the front of the cabinet. Then, each symbol comes to a stop automatically. At this time, with input by the spin button as a trigger, a lottery of random numbers is held when scroll of each symbol starts. When the result of the lottery of random numbers is transition to a bonus game such as mystery bonus and second bonus, the game is transited from the base game to the bonus game and the bonus game is executed.

Then, the slot machine pays out a pay out in accordance with a winning combination that occurs during the game.

In such a conventional slot machine, the symbols scrolled just come to a stop automatically and the advent of a slot machine equipped with new entertainment properties has been waited for.

### SUMMARY OF THE INVENTION

A slot machine according to a first aspect of the present invention comprises a controller. The controller executes either a base game in which plural symbols arranged on a display are rearranged automatically or a stop control game constituted by plural stop control unit games in which the symbols can be rearranged upon receipt of a control input signal from an external. When executing the stop control game, the controller increases or decreases the amount of credit to be given to a player in accordance with the number of times of stop control unit games in which the symbols were not rearranged in a specific combination. Further, the controller varies a stock rate for the credit stored cumulatively in a predetermined amount in accordance with the number of times.

The slot machine according to the first aspect of the present invention executes either the base game or the stop control game. The stop control game is constituted by plural stop control unit games. When executing the stop control game, the slot machine increases or decreases the amount of credit to be given to a player and also varies the stock rate in accordance with the number of times of the stop control unit game in which symbols were not rearranged in a specific combination.

A slot machine according to a second aspect of the present invention comprises a controller. The controller determines which one to execute between a base game in which plural symbols arranged on a display are rearranged automatically and a stop control game constituted by plural stop control unit games in which the symbols can be rearranged upon receipt of a control input signal from an external. When determining to execute the stop control game, the controller executes the stop control unit game more than once. The controller increases or decreases the amount of credit to be given to a player in accordance with the number of times of the stop control unit game in which the symbols were not rearranged in a specific combination. Further, the controller varies the stock rate for the credit stored cumulatively in a predetermined amount in accordance with the number of times.

The slot machine according to the second aspect of the present invention determines which one to execute between the base game and the stop control game. The stop control game is constituted by plural stop control unit games. When determining to execute the stop control game, the slot machine executes the stop control unit game more than once and increases or decreases the amount of credit to be given to a player and further varies the stock rate in accordance with the number of times of the stop control unit game in which symbols were not rearranged in a specific combination.

A slot machine according to a third aspect of the present invention comprises a display for arranging a symbol matrix formed by plural columns and plural rows, a stop switch that can be operated by a player and which outputs a control input signal in accordance with the operation of the player, and a controller. The controller determines which one to execute between a base game in which plural symbols arranged on a display are rearranged automatically and a stop control game constituted by plural stop control unit games in which the symbols can be rearranged upon receipt of a control input signal from the stop switch. When determining to execute the stop control game, the controller activates the stop switch and executes the stop control unit game more than once. As a result, the controller increases or decreases the amount of credit to be given to the player in accordance with the number of times of the stop control unit game in which the symbols were not rearranged in a specific combination, and further varies the stock rate for the credit stored cumulatively in a predetermined amount in accordance with the number of times.

The slot machine according to the third aspect of the present invention determines which one to execute between the base game and the stop control game. The stop control game is constituted by plural stop control unit games. When determining to execute the stop control game, the slot machine activates the stop switch, executes the stop control unit game more than once, and increases or decreases the amount of credit to be given to the player and further varies the stock rate in accordance with the number of times of the stop control unit game in which symbols were not rearranged in a specific combination.

In a playing method of a slot machine according to a fourth aspect of the present invention, either a base game in which plural symbols arranged on a display are rearranged automatically or a stop control game constituted by plural stop control unit games in which the symbols can be rearranged upon receipt of a control input signal from an external. When the stop control game is executed, the amount of credit to be given to a player in accordance with the number of times of the stop control unit game in which the symbols were not rearranged in a specific combination is increased or decreased. Further, the stock rate for the credit stored cumulatively in a predetermined amount is varied in accordance with the number of times.

In the playing method of a slot machine according to the fourth aspect of the present invention, either the base game or the stop control game is executed. The stop control game is constituted by plural stop control unit games. In the playing method of a slot machine, when the stop control game is executed, the amount of credit to be given to a player is increased or decreased and the stock rate is varied in accordance with the number of times of the stop control unit game in which symbols were not rearranged in a specific combination.

In a playing method of a slot machine according to a fifth aspect of the present invention, it is determined which one to execute between a base game in which plural symbols arranged on a display are rearranged automatically and a stop control game constituted by plural stop control unit games in which the symbols can be rearranged upon receipt of a control input signal from an external. When it is determined to execute the stop control game, the stop control unit game is executed more than once. As a result, the amount of credit to be given to a player in accordance with the number of times of the stop control unit game in which the symbols were not rearranged in a specific combination is increased or decreased and further the stock rate for the credit stored cumulatively in a predetermined amount is varied in accordance with the number of times.

In the playing method of a slot machine according to the fifth aspect of the present invention, it is determined which one to execute between the base game and the stop control game. The stop control game is constituted by plural stop control unit games. In the playing method of a slot machine, when it is determined to execute the stop control game, the stop control unit game is executed more than once. As a result, the amount of credit to be given to a player is increased or decreased and the stock rate is varied in accordance with the number of times of the stop control unit game in which symbols were not rearranged in a specific combination.

A playing method of a slot machine according to a sixth aspect of the present invention comprises a step of scrolling plural symbols arranged on a display, a step of determining which one to execute between a base game in which plural symbols arranged on a display are rearranged automatically and a stop control game constituted by plural stop control unit games in which the symbols can be rearranged upon receipt of a control input signal from a stop switch that can be operated by a player, and a step of, when it is determined to execute the stop control game, activating the stop switch, executing the stop control unit game more than once, and increasing or decreasing the amount of credit to be given to the player in accordance with the number of times of the stop control unit game in which the symbols were not rearranged in a specific combination, and further varying the stock rate for the credit stored cumulatively in a predetermined amount in accordance with the number of times.

In the playing method of a slot machine according to the sixth aspect of the present invention, it is determined which one to execute between the base game and the stop control game. The stop control game is constituted by plural stop control unit games. In the playing method of a slot machine, when it is determined to execute the stop control game, the stop switch is activated, the stop control unit game is executed more than once, and the amount of credit to be given to a player and further the stock rate is varied in accordance with the number of times of the stop control unit game in which symbols were not rearranged in a specific combination is increased or decreased.

### BRIEF DESCRIPTION OF THE DRAWINGS

FIG. 1 is a flow chart showing a playing method of a slot machine according to an embodiment of the present invention.

FIG. 2 is a perspective view showing an external appearance of the slot machine according to the embodiment of the present invention.

FIG. 3 is an explanatory diagram showing display windows according to the embodiment of the present invention.

FIG. 4 is a diagram showing symbols displayed on the slot machine according to the embodiment of the present invention, also showing the code number of each symbol.

FIG. 5 is a block diagram showing a control circuit of the slot machine according to the embodiment of the present invention.

FIG. 6 is a flow chart showing a procedure of authentication read processing of a game program and a game system program by a mother board and a gaming board of the slot machine according to the embodiment of the present invention.

FIG. 7 is a flow chart showing a procedure of main processing executed by the slot machine according to the embodiment of the present invention.

FIG. 8 is a flow chart showing a procedure of slot game execution processing executed by the slot machine according to the embodiment of the present invention.

FIG. 9 is a flow chart showing a procedure of stop control game execution processing executed by the slot machine according to the embodiment of the present invention.

FIG. 10A is an explanatory diagram showing an example of symbols rearranged on the slot machine according to the embodiment of the present invention.

FIG. 10B is an explanatory diagram showing an example of symbols rearranged on the slot machine according to the embodiment of the present invention.

FIG. 10C is an explanatory diagram showing an example of symbols rearranged on the slot machine according to the embodiment of the present invention.

FIG. 11 an explanatory diagram showing an example of a display notifying that a stop control game is being played in the slot machine according to the embodiment of the present invention.

### DETAILED DESCRIPTION OF THE INVENTION

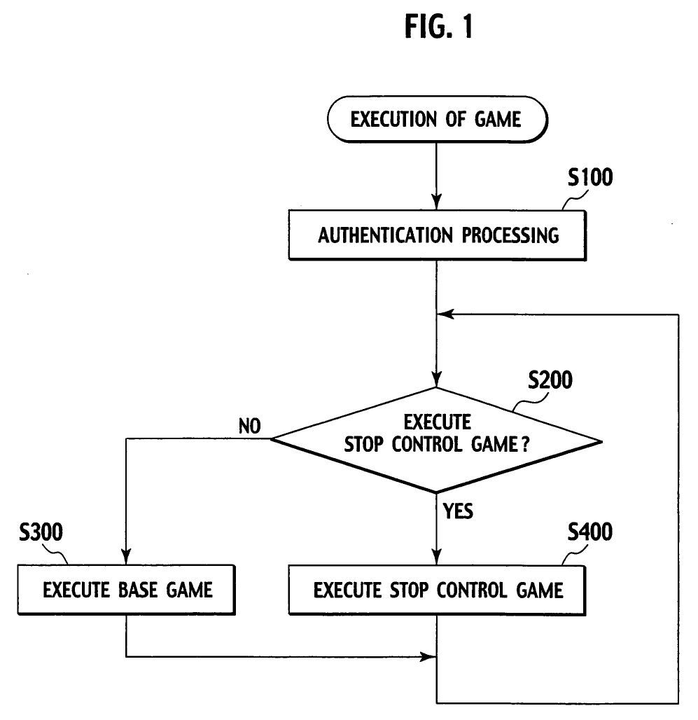

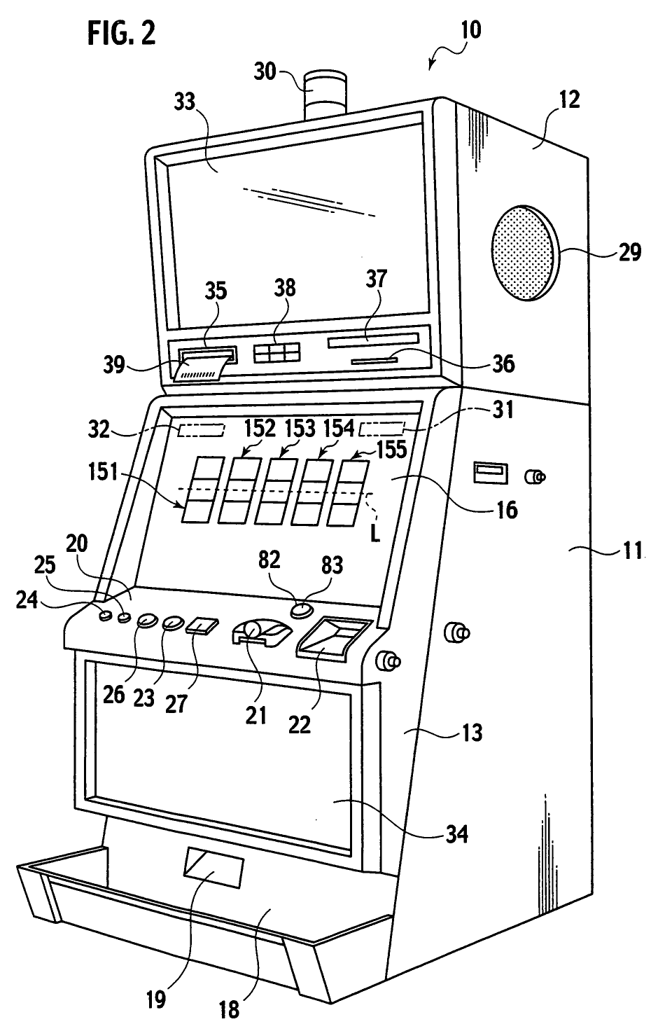

FIG. 1 is a flow chart schematically showing a playing method of a slot machine 10 according to an embodiment of the present invention. General operations of the slot machine 10 according to an embodiment of the present invention are explained below with reference to the flow chart shown in FIG. 1 and a perspective view shown in FIG. 2. By the way, the slot machine 10 is a slot machine of standalone type, not connected to a network, however, the present invention can also be applied to a slot machine connected to a network.

In step S100, when power is turned on and activated, the slot machine 10 according to an embodiment of the present invention first performs authentication processing. In the authentication processing, initial checking processing as to whether a program to activate the system operates normally or not, whether there is any falsification of a program or not, etc., is carried out.

In step S200, the slot machine 10 determines which one to execute between a base game and a stop control game. When determining to execute the stop control game, the slot machine 10 proceeds to step S400 and proceeds to step S300 when determining to execute the base game.

In step S300, the slot machine 10 executes the base game. In the base game, symbols are scrolled in display windows 151-155, respectively, and the symbols come to a stop automatically (that is, the symbols are rearranged automatically). In accordance with the combination of the symbols stopped, payout of coins or transition to a bonus game is performed. After this, the slot machine 10 returns to step S200. By the way, the bonus game is a game more advantageous for a player than the base game, and for example, a free game, a second game, etc., are included.

In step S400, the slot machine 10 executes the stop control game. The stop control game is constituted by ten stop control unit games. The number of times of stop control unit games constituting the stop control game is not limited to “10”. In the stop control unit game, symbols are scrolled in the display windows 151-155, respectively. Then, the symbols scrolled in the display windows 151-154 come to a stop automatically (that is, the symbols are rearranged) and the symbol scrolled in the display window 155 comes to a stop when a stop switch 82 is pressed by a player (that is, the symbol is rearranged). In other words, it is possible for the player to stop the symbols scrolled in the display window 155 by pressing the stop switch 82. The slot machine 10 increases or decreases the number (the amount) of coins (credit) to be paid out (given) to a player in accordance with the number of times of the stop control unit game in which a specific combination did not come to a stop on a payline L and also varies a stock rate for the coins stored cumulatively in a predetermined number in accordance with the number of times. The stored coins are used as coins for a jackpot. Then, the slot machine returns to step S200. In the present embodiment, a lower display panel 16 has the display windows 151-155 and the symbols are scrolled and stopped in the display windows 151-155. In other words, the slot machine adopts video reels. However, the present invention is not limited to a slot machine using video reels, but can also be applied to a slot machine using mechanical reels. In the present embodiment, the number of video reels is five, however, the number of video reels is arbitrary. In the present embodiment, the symbols are scrolled in the display windows 151-155, respectively, however, it may also be possible to design such that the symbols having come to a stop in the display windows 151-155 respectively are switched over at predetermined time intervals. In the present embodiment, only the symbols scrolled in the display window 155 stops by the stop operation by a player (that is, an operation to press the stop switch 82), however, it may also be possible to design such that the symbols scrolled in the display windows 151-154 also stop by the stop operation by a player.

Next, the configuration of the slot machine 10 according to an embodiment of the present invention is explained with reference to the perspective view shown in FIG. 2. The slot machine 10 is installed in a gaming facility.

In the slot machine 10, a coin, a bill, or a bar coded ticket 39 corresponding thereto is used as a game medium for executing the base game or the stop control game. However, in the present invention, the game medium is not limited in particular and for example, a medal, a token, and electronic money may be used.

As shown in FIG. 2, the slot machine 10 comprises a cabinet 11, a top box 12 mounted on the upper side of the cabinet 11, and a main door 13 provided on the front surface of the cabinet 11.

The main door 13 is provided with the lower display panel 16. The lower display panel 16 comprises a transmissive liquid crystal panel and displays various pieces of information about the game, effect images, etc., during the game.

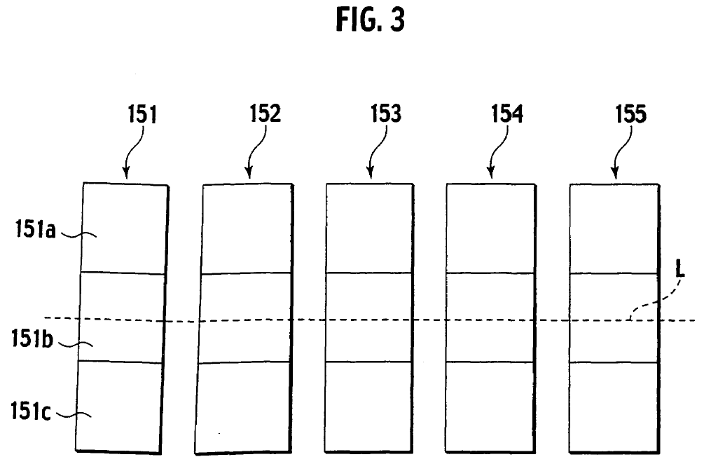

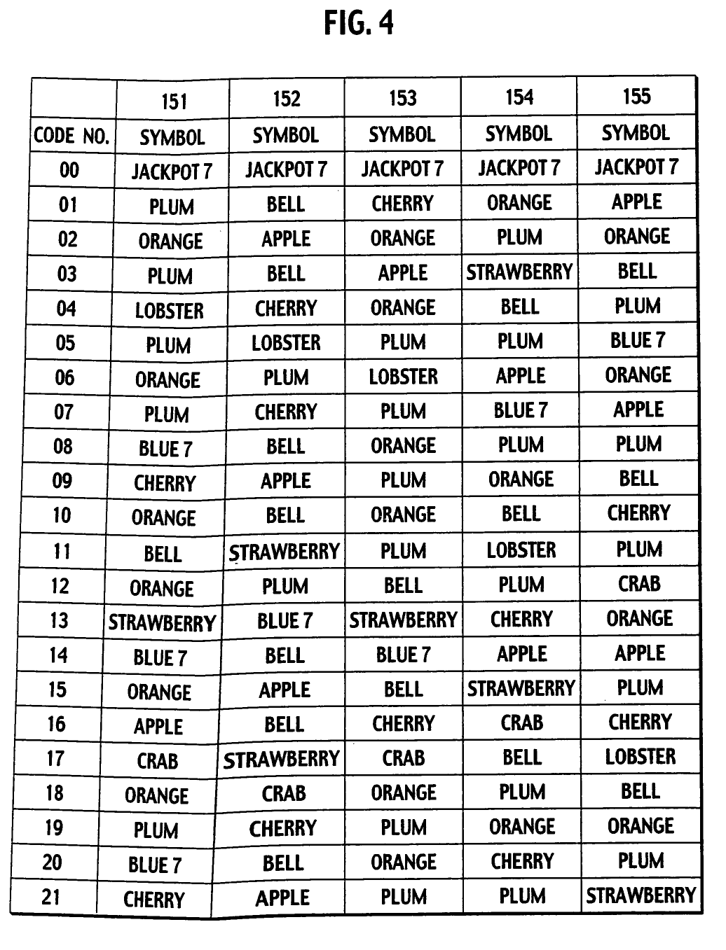

As shown in FIG. 3, the lower display panel 16 has the display windows 151-155 and scrolls the symbol columns shown in FIG. 4 in the display windows 151-155. Due to this, the lower display panel 16 scrolls the symbols in the display windows 151-155. Each symbol column is constituted by 22 symbols and the symbols constituting each symbol column are assigned with any one of code numbers 0-21. After scrolling the symbols in the display windows 151-155 of the lower display panel 16, the respective symbols are stopped in an upper row, a middle row, and a lower row of the display windows 151-155. For example, on the lower display panel 16, the symbols are scrolled in the display window 151 and then “ORANGE (code number: 06)” is stopped in an upper tier 151a of the display window 151, “PLUM (code number: 07)” is stopped in a middle tier 151b of the display window 151, and “BLUE 7 (code number: 08)” is stopped in a lower tier 151c of the display window 151. Due to this, a symbol matrix formed by plural columns and plural rows is displayed in the lower display panel 16.

By the way, in the present embodiment, the symbols are displayed using the lower display panel 16, however, it may also be possible to display the symbols using plural reels on the circumferential surfaces of which the symbols are drawn. In this case, the symbols are scrolled when the reels rotate and the symbols stop when the rotation of the reels stops. There are five display windows, however, the number of display windows is not limited to five.

In the lower display panel 16, one payline L crossing horizontally the middle row of the display windows 151-155 is formed. The payline L defines a combination of symbols. In other words, in the base game, when the combination of symbols that have stop on the payline L is a winning combination, coins are paid out in accordance with the combination of the symbols and the number of bets. On the other hand, in the stop control game, the number of coins to be paid out to a player is increased or decreased in accordance with the number of times of the stop control unit game in which a specific combination did not stop on the payline L and the stock rate is varied in accordance with the number of times.

By the way, in the present embodiment, the payline L crosses the middle row of the display windows 151-155, however, the payline L may cross the other row of the display windows 151-155. For example, the payline L may cross the upper row of the display windows 151-155, or may cross the lower tier of the display window 151, the middle tier of the display window 152, and the upper tier of the display window 153. The number of paylines L is also arbitrary. When the number of paylines L is two or more, all of the paylines L may be activated, or the number of paylines L in accordance with the number of bets of coin may be activated. In the base game or the stop control game, the above-described processing is performed based on only the symbols that have stop on the activated payline(s) L.

The lower display panel 16 is provided with a credit number display section 31 and a payout number display section 32. The credit number display section 31 displays the total number of coins that can be paid out to a player by the slot machine 10 (hereinafter, also referred to as “total number of credits”). The total number of credits is stored in a RAM 43, which will be described later. The payout number display section 32 displays the number of coins to be paid out when the combination of the symbols that have stop on the payline L is a winning combination.

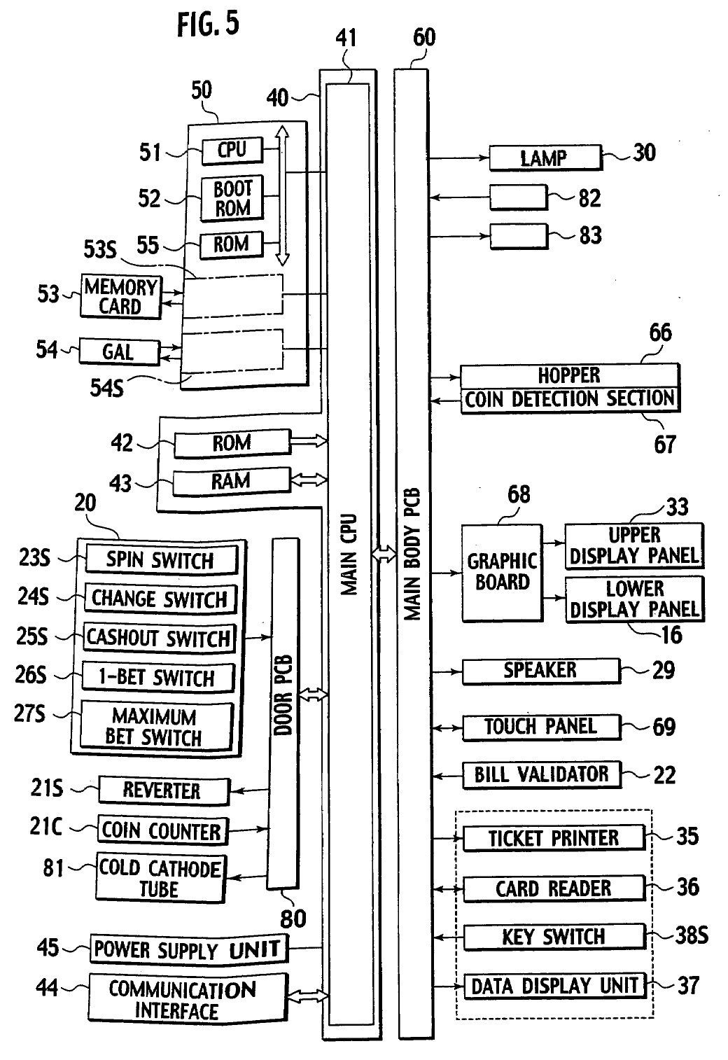

Further, on the front surface of the lower display panel 16, a touch panel 69 (refer to FIG. 5) is provided and it is possible for a player to input various directions by operating the touch panel 69.

Below the lower display panel 16, a control panel 20 constituted by plural buttons 23 to 27 with which directions relating to the progress in the game are input by a player, the stop switch 82, a coin insertion slot 21 for insert a coin into the cabinet 11, and a bill validator 22 are provided. In the present embodiment, a configuration is made such that the stop switch 82 of mechanical type is provided, however, this is not limited and it may also be possible to use a transmissive touch panel as the stop switch 82 by arranging the touch panel in front of a display window 15.

As such a touch panel, a touch panel adopted in a mobile terminal or an ATM in a bank may be used. As described above, by arranging a touch panel in front of the display window 15 as the stop switch 82, it is made possible for a player to issue a stop direction by touching the symbol desired to be made to stop (rearranged) by a player while visually recognizing the symbols scrolled in the display window 155. Such a stop operation has an advantageous in being performed with the feeling of touching the symbol directly.

In the present embodiment, the configuration is such that only one stop switch 82 of mechanical type is provided, however, this is not limited and it may also be possible to provide the stop switch 82 in each display window and when any one of the stop switches 82 is pressed, the symbols in the display window corresponding to the stop switch 82 are made to stop.

Due to this, it is made possible to switch from a play mode in which a player is involved with rearrangement of symbols in one display window by inputting through the stop switch to a play mode in which a player is involved with rearrangement of symbols in plural display windows.

The control panel 20 is provided with a spin button 23, a change button 24, a cashout button 25, a 1-bet button 26, and a maximum bet button 27. The spin button 23 is a button to input a direction to initiate scrolling of symbols. The change button 24 is a button used for a request to a person in charge in a gaming facility for exchange. The cashout button 25 is a button to input a direction to pay out coins in accordance with the total number of credits onto a coin tray 18.

The 1-bet button 26 is a button to input a direction to bet one coin for a game among the total number of credits. The maximum bet button 27 is a button to input a direction to bet coins in the maximum number of coins that can be bet for one game (for example, 50 coins).

The stop switch 82 is a switch, which is activated when the stop control unit game is started and used by a player to perform an operation of stopping symbols scrolled in the display window 155, that is, a stop operation. Further, the stop switch 82 is provided with a display lamp 83 and as will be described later, the display lamp 83 turns on when the stop switch 82 is activated, notifying a player that the stop switch 82 is activated. By the way, instead of the stop switch 82, an operation lever, a track ball, a touch panel, etc., can be used.

The bill validator 22 identifies whether or not a bill is real as well as receiving a real bill into the cabinet 11. Further, the bill validator 22 reads a bar codes ticket 39 to be described later. After reading the bar coded ticket 39, the bill validator 22 outputs a read signal relating to the read contents to a main CPU 41.

On the lower front surface of the main door 13, that is, below the control panel 20, a berry glass 34 is provided, on which the character of the slot machine 10 etc. is drawn.

On the front surface of the top box 12, an upper display panel 33 is provided. The upper display panel 33 comprises a liquid crystal panel and for example, effect images and images introducing the contents of a game and explaining the rules of the game are displayed.

Further, the top box 12 is provided with a speaker 29 for outputting voices. At the lower side of the upper display panel 33, a ticket printer 35, a card reader 36, a data display unit 37, and a keypad 38 are provided. The ticket printer 35 prints on a ticket the bar code into which data of the total number of credits, the number of credits for jackpot, date, the identification number of the slot machine 10, etc., is coded, and outputs the ticket as the bar coded ticket 39. There exists in the stop control game a chance that coins in accordance with the number of credits for jackpot are paid out. In other words, the main CPU 41 determines whether or not to pay out coins in accordance with the number of credits for jackpot only when the number of credits for jackpot becomes equal to or greater than a predetermined jackpot threshold value (for example, “500”) and a specific combination stops on the payline L five times or more successively. The main CPU 41 pays out coins in accordance with the number of credits for jackpot only when having determined to pay out coins in accordance with the number of credits for jackpot. By the way, the number of credits for jackpot is stored in the RAM 43.

It is possible for a player to play a game with another slot machine by using the bar coded ticket 39 or exchange the bar coded ticket 39 for bills etc. at a cashier etc. in a gaming facility.

The card reader 36 reads data from a smart card and writes data to a smart card. The smart card is a card possessed by a Player and for example, data for identifying a player and data relating to the history of the games played by the player are stored.

The data display unit 37 is constituted by a fluorescent display etc. and displays, for example, data read by the card reader 36 and data input by a player through the keypad 38. The keypad 38 inputs a direction or data relating to issuance of a ticket etc.

FIG. 4 is an explanatory diagram showing symbol columns scrolled in the display windows 151-155. Each symbol column is constituted by 22 symbols. Each symbol column is different from another. Each symbol column is configured by combining symbols of “JACKPOT 7”, “BLUE 7”, “BELL”, “CHERRY”, “STRAWBERRY”, “PLUM”, “ORANGE”, “APPLE”, “LOBSTER”, and “CRAB”.

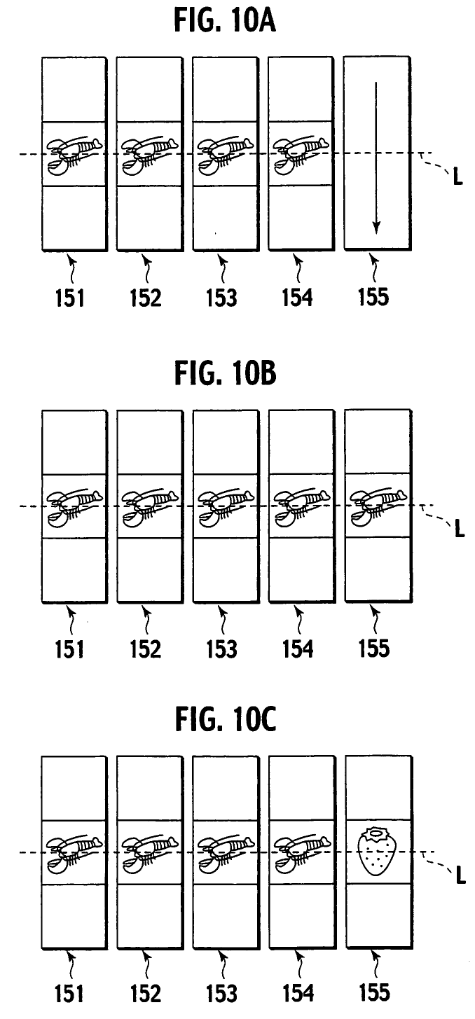

In the stop control unit game, “LOBSTER” stops automatically in the middle row of the display windows 151-154 (refer to FIG. 10A) and “LOBSTER” or another symbol will stop in the middle row of the display window 155 in response to a stop operation by a player (refer to FIGS. 10B-10C). Depending on the number of times of the stop control unit game in which a specific combination did not stop on the payline L, the number of coins to be paid out to a player and the stock rate differ. In other words, the “LOBSTER” symbol is a symbol that forms a specific combination. By the way, when symbols stop in the middle row of the display windows 151-155, other symbols also stop in the upper row and the lower row of the display windows 151-155, however, in FIGS. 10A-10C, the symbols that stop in the upper row and the lower row of the display windows 151-155 are omitted.

Further, various winning combinations constituted by plural symbols (for example, five “JACKPOT 7”s) and the number of coins to be paid out in accordance with each winning combination are determined in advance and in the base game, when symbols that form a winning combination stop on the payline L, the number of coins to be paid out in accordance with the winning combination is added to the total number of credits.

FIG. 5 is a block diagram showing a control circuit of the slot machine 10 shown in FIG. 2. As shown in FIG. 5, the control circuit is constituted by components such as a mother board 40, a main body PCB (Printed Circuit Board) 60, a gaming board 50, a door PCB 80, and various switches and sensors.

The gaming board 50 comprises a CPU (Central Processing Unit) 51, a ROM 55, and a boot ROM 52 connected to each other by an internal bus, and a card slot 53S conforming to a memory card 53, and an IC socket 54S conforming to a GAL (Generic Array Logic) 54.

The memory card 53 stores a game program and a game system program. The game program includes a stop symbol determination program. The stop symbol determination program is a program to determine symbols (code numbers corresponding to symbols) that stop on the payline L. The stop symbol determination program includes symbol-weighted data corresponding to payout rates of plural kinds (for example, 80%, 84%, 88%), respectively. The symbol-weighted data is data showing a correspondence between the code number of each symbol (refer to FIG. 4) and one or plural random number values belonging to a predetermined numerical value range (0 to 255) as to each of the display windows 151-155.

The payout rate is determined based on data for setting payout rate output from the GAL 54 and symbols that stop on the payline L are determined based on the symbol-weighted data corresponding to the payout rate.

Further, the card slot 53S is configured such that the memory card 53 can be inserted or removed and connected to the mother board 40 by an IDE bus. Therefore, it is possible to change the kind or contents of the game played with the slot machine 10 by removing the memory card 53 from the card slot 53S, writing another game program and game system program to the memory card 53, and inserting the memory card 53 into the card slot 53S.

The game program includes a program relating to the progress in the game and a program for transiting to a bonus game. Further, the game program includes image data and audio data output during the game. Furthermore, the game program includes image data and audio data as notification data for notifying a player that a stop operation is possible by the stop switch 82 when the stop control game is played.

The GAL 54 comprises plural input ports and output ports and when data is input to the input port, data corresponding to the data is output from the output port. The data output from the output port is the data for setting payout rate described above.

The IC socket 54S is configured such that the GAL 54 can be attached thereto and removed therefrom, and connected to the mother board 40 by a PCI bus. Therefore, it is possible to change the data for setting payout rate output from the GAL 54 by removing the GAL 54 from the IC socket 54S, rewriting the program stored in the GAL 54, and attaching the GAL 54 to the IC socket 54S.

The CPU 51, the ROM 55, and the boot ROM 52 connected to each other by the internal bus are connected to the mother board 40 by the PCI bus. The PCI bus performs signal transmission between the mother board 40 and the gaming board 50 and supplies power from the mother board 40 to the gaming board 50. In the ROM 55, country identification information and an authentication program are stored. In the boot ROM 52, a preliminary authentication program and a program (boot program) for the CPU 51 to activate the preliminary authentication program, etc., are stored.

The authentication program is a program (falsification check program) for authenticating a game program and a game system program. The authentication program is a program for confirming and proving that a game program and a game system program are not falsified. In other words, the authentication program is coded in accordance with a procedure for performing authentication of a game program and a game system program. The preliminary authentication program is a program for authenticating the authentication program described above. The preliminary authentication program is coded in accordance with a procedure for proving that the authentication program to be subjected to authentication processing is not falsified, that is, for performing authentication of the authentication program.

The mother board 40 comprises the main CPU 41 (controller), a ROM (Read Only Memory) 42, the RAM (Random Access Memory) 43, and a communication interface 44.

The main CPU 41 comprises a function as a controller for controlling the entire slot machine 10. In particular, the main CPU 41 determines which one to execute between the base game and the stop control game when a part or all of the coins among those in accordance with the total number of credits are bet and the spin button 23 is pressed, and when determining to execute the stop control game, performs the stop control game execution processing and when determining to execute the base game, performs the base game execution processing.

The main CPU 41 outputs a scroll instruction signal to scroll symbols in the display windows 151-155 to a graphic board 68 both in the stop control game execution processing and in the base game execution processing. The graphic board 68 controls the lower display panel 16 based on the scroll instruction signal. The lower display panel 16 scrolls symbols in the display windows 151-155 by the control of the graphic board 68 (that is, the control of the main CPU 41).

In the base game execution processing, the CPU 41 determines all of the symbols that stop on the payline L and outputs an all stop instruction signal relating to the determined symbols to the graphic board 68. The graphic board 68 controls the lower display panel 16 based on the all stop instruction signal. On the lower display panel 16, the symbols shown by the all stop instruction signal to stop on the payline L by the control of the graphic board 68. Due to this, the lower display panel 16 rearranges a new symbol matrix.

On the other hand, in the stop control game execution processing, the main CPU 41 determines “LOBSTER” for the symbols caused to stop in the display windows 151-154 among the symbols that stop on the payline L and outputs a partial stop instruction signal relating to the determined symbols to the graphic board 68. The graphic board 68 controls the lower display panel 16 based on the partial stop instruction signal. The lower display panel 16 causes “LOBSTER” to stop in the middle row of the display windows 151-154 by the control of the graphic board 68 as shown in FIG. 10A, and continues scrolling in the display window 155. The main CPU 41 activates the stop switch 82 (that is, receives a control input signal from the stop switch 82) and with the timing of reception of the control input signal from the stop switch 82, outputs a final stop instruction signal to cause a symbol to stop in the display window 155 to the graphic board 68, and the graphic board 68 controls the lower display panel 16 based on the final stop instruction signal. The lower display panel 16 determines the condition that “LOBSTER” is currently displayed in the middle tier or the upper tier of the display window 155 by the control of the graphic board 68, and causes “LOBSTER” to stop in the middle tier of the display window 155 as shown in FIG. 10B only when the condition is met.

In the ROM 42, programs such as a BIOS (Basic Input/Output System) executed by the main CPU 41 are stored and data to be used permanently is stored. When the BIOS is executed by the main CPU 41, the initialization processing of the respective peripherals is performed and the read processing of the game program and the game system program via the gaming board 50 is started.

In the RAM 43, data and programs used when the main CPU 41 performs processing are stored. Further, the RAM 43 comprises a region for storing the number “n” of times of failure in stop, a region for storing the number “m” of times of success in stop, a region for storing the number “r” of times of execution of the stop control unit game, a region for storing the number of credits for jackpot, and a region for storing the total number of credits. The number “n” of times of failure in stop, the number “m” of times of success in stop, and the number “r” of times of execution of the stop control unit game are used in the stop control game.

The communication interface 44 is used to perform communication with a host computer etc. provided in a gaming facility via a communication line.

To the mother board 40, the main body PCB (Printed Circuit Board) 60 and the door PCB 80, which will be described later, are also connected via a USB (Universal Serial Bus), respectively. Further, to the mother board 40, a power supply unit 45 is connected. When power is supplied from the power supply unit 45 to the mother board 40, the main CPU 41 of the mother board 40 is activated and at the same time, power is supplied to the gaming board 50 via the PCI bus and the CPU 51 is activated.

To the main body PCB 60 and the door PCB 80, apparatuses and devices for generating input signals to be input to the main CPU 41 and apparatuses and devices the operations of which are controlled by control signals output from the main CPU 41 are connected. The main CPU 41 performs operation processing and stores its result in the RAM 43 by executing the game program and game system program stored in the RAM 43 and performs processing to transmit a control signal to each of the apparatuses and devices as control processing for each of the apparatuses and devices based on the input signal input to the main CPU 41.

To the main body PCB 60, a lamp 30, a hopper 66, a coin detection section 67, the graphic board 68, the speaker 29, the touch panel 69, the bill validator 22, the ticket printer 35, the card reader 36, a key switch 38S, and the data display unit 37 are connected. Further, to the main body PCB 60, the stop switch 82 and the display lamp 83 are connected.

The turning-on and turning-off of the lamp 30 are controlled based on a control signal output from the main CPU 41.

The hopper 66 is mounted in the cabinet 11 and pays out coins in the predetermined number onto the coin tray 18 from a coin payout opening 19 based on the control signal output from the main CPU 41. The coin detection section 67 is provided in the coin payout opening 19 and outputs an input signal to the main CPU 41 when detecting that coins in the predetermined number have been paid out from the coin payout opening 19.

The graphic board 68 controls the image display on the upper display panel 33 and the lower display panel 16 based on the control signal output from the main CPU 41. On the credit number display section 31 of the lower display panel 16, the total number of credits stored in the RAM 43 is displayed. Further, on the payout number display section 32 of the lower display panel 16, the number of coins to be paid out is displayed. Furthermore, the graphic board 68 comprises a VDP (Video Display Processor) for generating image data based on the control signal output from the main CPU 41, a video RAM for temporarily storing image data generated by the VDP, etc.

The bill validator 22 reads the image of a bill and receives a real bill into the cabinet 11. When receiving a real bill, the bill validator 22 outputs an input signal to the main CPU 41 based on the amount of the bill. The main CPU 41 adds the number of credits in accordance with the amount of the bill transmitted by the input signal to the total number of credits.

The ticket printer 35 prints bar code into which data such as the total number of credits stored in the RAM 43, the date and the identification number of the slot machine 10, and the number of credits for jackpot has been encoded, and outputs as the bar coded ticket 39.

The card reader 36 reads data from the smart card and transmits the data to the main CPU 41 and writes data to the smart card based on the control signal from the main CPU 41. The key switch 38S is provided at the keypad 38 and outputs an input signal to the main CPU 41 when the keypad 38 is operated by a player.

The data display unit 37 displays the data read by the card reader 36 and the data input by a player via the keypad 38 based on the control signal output from the main CPU 41.

The stop switch 82 is a switch for causing the symbols to stop in the display window 155 when the stop control game to be described later is executed. The stop switch 82 outputs a predetermined control input signal to the main CPU 41 when pressed by a player.

To the door PCB 80, the control panel 20, a reverter 21S, a coin counter 21C, and a cold cathode tube 81 are connected. The control panel 20 is provided with a spin switch 23S in accordance with the spin button 23, a change switch 24S in accordance with the change button 24, a cashout switch 25S in accordance with the cashout button 25, a 1-bet switch 26S in accordance with the 1-bet button 26, and a maximum bet switch 27S in accordance with the maximum bet button 27. Each of the switches 23S to 27S outputs an input signal to the main CPU 41 when each of the corresponding buttons 23 to 27 is operated by a player.

The coin counter 21C is provided in a coin insertion slot 21 and identifies whether or not the coin inserted into the coin insertion slot 21 by a player is real. Coins other than the real ones are ejected from the coin payout opening 19. The coin counter 21C outputs an input signal to the main CPU 41 when detecting a real coin.

The reverter 21S operates based on the control signal output from the main CPU 41 and sorts the coins recognized as real ones by the coin counter 21C into a cash box (not shown) mounted in the slot machine 10 or into the hopper 66. That is, when the hopper 66 is filled with coins, real coins are sorted into the cash box by the reverter 21S. On the other hand, when the hopper 66 is not filled with coins, real coins are sorted into the hopper 66.

The cold cathode tube 81 functions as a backlight mounted on the backside of the lower display panel 16 and the upper display panel 33 and turns on based on the control signal output from the main CPU 41.

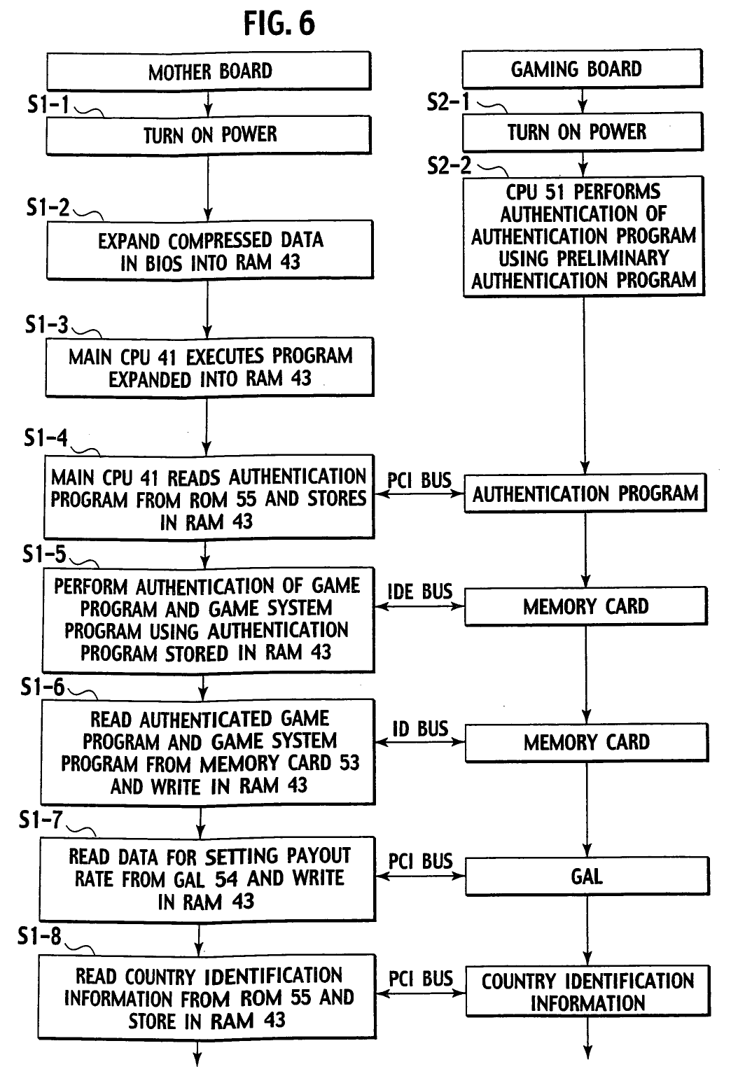

Next, specific processing performed in the slot machine 10 is explained. FIG. 6 is a flow chart showing the procedure (procedure in step S100 shown in FIG. 1) of authentication read processing of the game program and the game system program by the mother board 40 and the gaming board 50 shown in FIG. 5. By the way, it is assumed that the memory card 53 is attached to the card slot 53S and the GAL 54 is attached to the IC socket 54S in the gaming board 50.

First, when the power switch is turned on in the power supply unit 45, the mother board 40 and the gaming board 50 are activated (steps S1-1, S2-1). When the mother board 40 and the gaming board 50 are activated, individual processing is performed in parallel. In other words, in the gaming board 50, the CPU 51 reads the preliminary authentication program stored in the boot ROM 52 and in accordance with the read preliminary authentication program, performs in advance preliminary authentication to confirm and prove that the authentication program has not been falsified before taken in by the mother board 40 (step S2-2).

On the other hand, in the mother board 40, the main CPU 41 executes the BIOS stored in the ROM 42 and expands the compressed data incorporated in the BIOS into the RAM 43 (step S1-2). Then, the main CPU 41 executes the BIOS expanded in the RAM 43 and performs diagnosis and initialization of the various peripherals (step S1-3).

Then, since the ROM 55 of the gaming board 50 is connected to the main CPU 41 via the PCI bus, the main CPU 41 reads the authentication program stored in the ROM 55. Further, the main CPU 41 performs processing to store the read authentication program in the RAM 43 (step S1-4).

Next, the main CPU 41 accesses the memory card 53 attached to the card slot 53S via the IDE bus. Then, the main CPU 41 reads the game program and the game system program stored in the memory card 53.

Next, the main CPU 41 performs authentication to confirm and prove that the read game program and game system program have not been falsified in accordance with the authentication program stored in the RAM 43 (step S1-5).

When the authentication processing is completed normally, the main CPU 41 stores the authenticated game program and game system program in the RAM 43 (step S1-6). Next, the main CPU 41 accesses the GAL 54 attached to the IC socket 54S via the PCI bus, reads data for setting payout rate from the GAL 54, and stores it in the RAM 43 (step S1-7). Next, the main CPU 41 reads country identification information stored in the ROM 55 of the gaming board 50 via the PCI bus and stores the read country identification information in the RAM 43 (step S1-8).

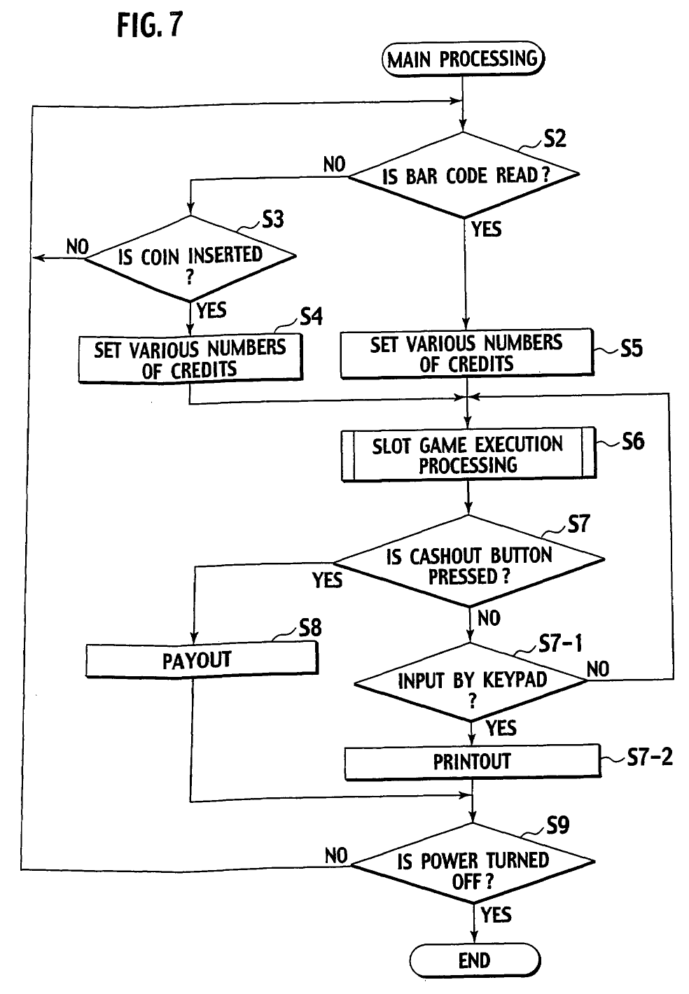

After performing the above-described processing, the main CPU 41 sequentially reads the game program and the game system program and executes the programs. Specifically, the main CPU 41 performs main processing shown in FIG. 7. In other words, in step S2, the main CPU 41 determines the condition that a read signal is given from the bill validator 22 and proceeds to step S5 when the condition is met and proceeds to step S3 when the condition is not met.

In step S3, the main CPU 41 determines the condition that an input signal is given from the coin counter 21C or the bill validator 22 and proceeds to step S4 when the condition is met and proceeds to step S2 when the condition is not met.

In step S4, the main CPU 41 sets the total number of credits and sets the number of credits for jackpot to “0” based on the input signal given from the coin counter 21C or the bill validator 22. Then, the main CPU 41 proceeds to step S6.

In step S5, the main CPU 41 sets the total number of credits and the number of credits for jackpot based on the read signal given from the bill validator 22. Then, the main CPU 41 proceeds to step S6.

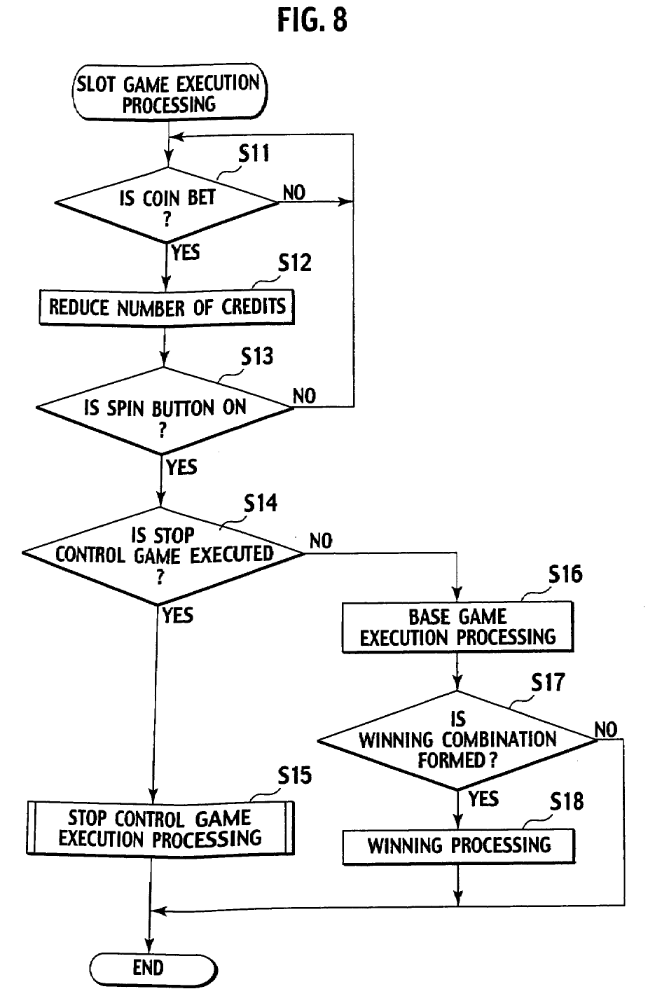

In step S6, the main CPU 41 performs slot game execution processing shown in FIG. 8. Generally, the main CPU 41 determines which one to execute between the base game and the stop control game and executes the stop control game when determining to execute the stop control game, and executes the base game when determining to execute the base game.

In step S7, the main CPU 41 determines the condition that an input signal is given from the cashout switch 25S and proceeds to step S8 when the condition is met and proceeds to step S7-1 when the condition is not met.

In step S7-1, the main CPU 41 determines the condition that an input signal to request the issuance of the bar coded ticket 39 is given from the key switch 38S and proceeds to step S7-2 when the condition is met and returns to step S6 when the condition is not met.

In step S7-2, the main CPU 41 causes the ticket printer 35 to output the bar coded ticket 39 and resets the total number of credits and the number of credits for jackpot to “0”. Then, the main CPU 41 proceeds to step S9.

In step S8, the main CPU 41 outputs a control signal to pay out coins in accordance with the total number of credits to the hopper 66 and the hopper 66 pays out coins in accordance with the total number of credits onto the coin tray 18 from the coin payout opening 19 based on the control signal. Then, the main CPU 41 resets the total number of credits and the number of credits for jackpot to “0” and proceeds to step S9.

In step S9, the main CPU 41 ends the main processing if the power source of the slot machine 10 is turned off, or returns to step S2 while the power source of the slot machine 10 is kept on. By the way, if an input signal is given from the coin counter 21C or the bill validator 22 during the period of performance of the main processing, the main CPU 41 interrupts the main processing and increases the total number of credits based on the input signal.

FIG. 8 is flow chart showing the procedure of slot game execution processing. In step S11, the main CPU 41 judges whether or not a coin is bet. In this processing, the main CPU 41 judges whether or not an input signal that is output from the 1-bet switch 26S when the 1-bet button 26 is pressed or an input signal that is output from the maximum bet switch 27S when the maximum bet button 27 is pressed is received. When judging that no coin has been bet, the main CPU 41 returns to step S11 or proceeds to step S12 when judging that a coin has been bet.

In step S12, the main CPU 41 performs processing to reduce the total number of credits stored in the RAM 43 in accordance with the number of bet coins and proceeds to step S13. By the way, when the number of bet coins is greater than the total number of credits stored in the RAM 43 or when the number of bet coins exceeds the upper limit value (50 in the present embodiment) of the number of coins that can be bet for one game, the main CPU 41 returns processing to step S11 without performing processing to reduce the total number of credits stored in the RAM 43.

In step S13, the main CPU 41 judges whether or not the spin button 23 is turned on. In this processing, the main CPU 41 judges whether or not an input signal that is output from the spin switch 23S is received.

When judging that the spin button 23 is not turned on, the main CPU 41 returns processing to the step S11 or proceeds to step S14 when judging that the spin button 23 is turned on. By the way, the main CPU 41 cancels the reduction result in step S12 when the spin button 23 is not turned on and a direction to end the game is input (it can be thought that a direction to end the game is issued, for example, when the cashout button 25 is pressed or issuance of the bar coded ticket 39 is requested).

In the present embodiment, the main CPU 41 performs processing to reduce the total number of credits (step S12) before judging whether or not the spin button 23 is turned on (step S13) after coins are bet (step S11). However, the present invention is not limited to this example. For example, it may also be possible for the main CPU 41 to judge whether or not the spin button 23 is turned on (step S13) after coins are bet (step S11) and perform processing to reduce the total number of credits (step S12) when judging that the spin button 23 is turned on.

In step S14, the main CPU 41 determines which one to execute between the base game and the stop control game. Specifically, the main CPU 41 generates one random number in the range of 0 to 255 and determines the condition that the generated random number is included in a predetermined stop control game execution random number range (for example, the range of 0 to 50). When the condition is met, the main CPU 41 determines to execute the stop control game and when the condition is not met, determines to execute the base game. When determining to execute the stop control game, the main CPU 41 proceeds to step S15 and proceeds to step S16 when determining to execute the base game.

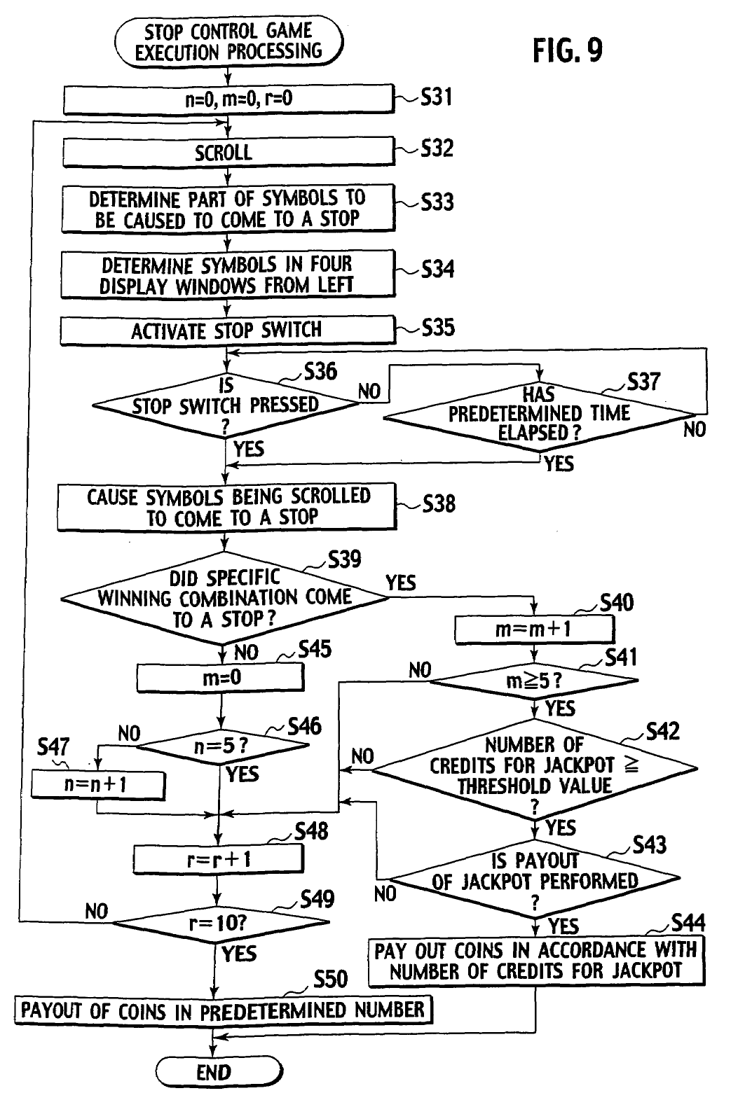

In step S15, the main CPU 41 performs the stop control game execution processing shown in FIG. 9. Generally, the main CPU 41 starts the stop control unit game by scrolling the symbols in the display windows 151-155. As shown in FIG. 10A, the main CPU 41 causes “LOBSTER” to stop in the middle row of the display windows 151-154 and continues to scroll the symbols in the display window 155. Then, the main CPU 41 activates the stop switch 82. As shown in FIGS. 10B-10C, the main CPU 41 causes “LOBSTER” or a symbol other than that to stop in the middle tier of the display window 155 in accordance with the timing when the stop switch 82 is pressed. By this, the main CPU 41 ends the stop control unit game. The main CPU 41 executes the stop control unit game 10 times.

The main CPU 41 determines the number of coins to be paid out to a player and the stock rate in accordance with the number of times of the stop control unit game in which a specific combination (that is, five “LOBSTER”s) did not stop on the payline L. Then, the main CPU 41 ends the slot game execution processing. Therefore, by executing the stop control game execution processing, the main CPU 41 receives a control input signal from an external and executes the stop control unit game in which rearrangement of the symbols is enabled plural times.

In step S16, the main CPU 41 performs the base game execution processing. Specifically, the main CPU 41 outputs a scroll instruction signal to cause the display windows 151-155 to scroll the symbols to the graphic board 68. The graphic board 68 controls the lower display panel 16 based on the scroll instruction signal. The lower display panel 16 causes the display windows 151-155 to scroll the symbols by the control of the graphic board 68. The symbols are scrolled in the display windows 151-155, thereby the base game is started. The main CPU 41 determines all of the symbols that are caused to stop on the payline L. Specifically, the main CPU 41 generates one random number value in the range of 0 to 255 for each of the display windows 151-155. The main CPU 41 refers to symbol-weighted data in accordance with the data for setting payout rate output from the GAL 154 and stored in the RAM 43 and determines the code numbers (refer to FIG. 4) of the symbols that are caused to stop in the middle row of the display windows 151-155. Due to this, the main CPU 41 determines the symbols that are caused to stop in the middle row of the display windows 151-155. The main CPU 41 outputs the all stop instruction signal relating to the determined symbols to the graphic board 68. The graphic board 68 controls the lower display panel 16 based on the all stop instruction signal. On the lower display panel 16, the symbols indicated by the all stop instruction signal are stopped on the payline L by the control of the graphic board 68. Due to this, the lower display panel 16 rearranges a new symbol matrix. The symbols stop in the display windows 151-155, thereby the base game is over. Therefore, by performing the base game execution processing, the main CPU 41 executes the base game in which the plural symbols arranged in the lower display panel are automatically rearranged. Then, the main CPU 41 proceeds to step S17.

In step S17, the main CPU 41 determines the condition that the combination of the symbols that have stopped on the payline L is a winning combination and proceeds to step S18 when the condition is met and ends the slot game execution processing when the condition is not met.

In step S18, the main CPU 41 performs winning processing. Specifically, the main CPU 41 pays out coins in the predetermined number in accordance with the winning combination that has stopped on the payline L (substantially, the total number of credits is increased by the predetermined number) or executes a bonus game. Then, the main CPU 41 ends the slot game execution processing.

FIG. 9 is a flow chart showing the procedure of the stop control game execution processing. In step S31, the main CPU 41 resets the number “n” of times of failure in stop, the number “m” of times of success in stop, and the number “r” of times of execution of the stop control unit game to “0”, respectively.

In step S32, the main CPU 41 outputs a scroll instruction signal to scroll the symbols in the display windows 151-155 to the graphic board 68. The graphic board 68 controls the lower display panel 16 based on the scroll instruction signal. On the lower display panel 16, the symbols are scrolled in the display windows 151-155 by the control of the graphic board 68. The symbols are scrolled in the display windows 151-155, thereby the stop control unit game is started.

In step S33, the main CPU 41 determines a part of the symbols that are caused to stop on the payline L. Specifically, the main CPU 41 determines the symbols that are caused to stop in the middle row of the display windows 151-154 to be “LOBSTER”. Then, the main CPU 41 proceeds to step S34.

In step S34, the main CPU 41 outputs the partial stop instruction signal relating to the symbols determined in step S33 to the graphic board 68. The graphic board 68 controls the lower display panel 16 based on the partial stop instruction signal. On the lower display panel 16, “LOBSTER” is stopped in the middle row of the display windows 151-154 by the control of the graphic board 68 as shown in FIG. 10A and continues scrolling in the display window 155.

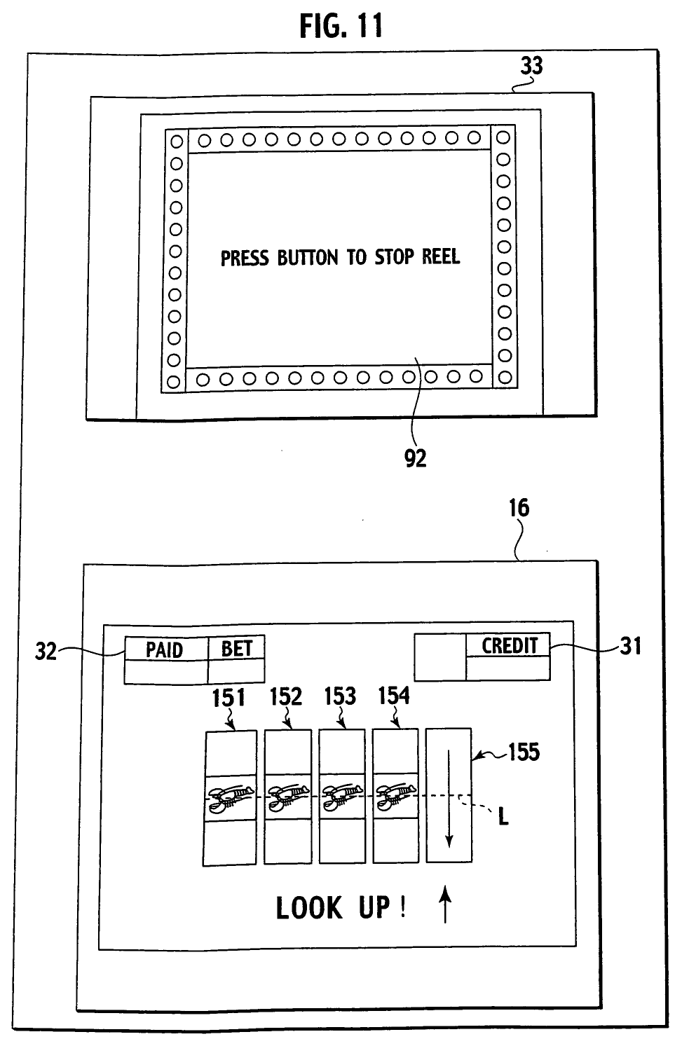

In step S35, the main CPU 41 activates the stop switch 82 (that is, receives a control input signal from the stop switch 82). Further, the main CPU 41 turns on the display lamp 83. Furthermore, the main CPU 41 generates a stop control game effect instruction signal to display text information such as “LOOK UP! ” and “PRESS BUTTON TO STOP REEL” and outputs the signal to the graphic board 68. The graphic board 68 displays the text image of “PRESS BUTTON TO STOP REEL” in the upper display panel 33 and displays the text image of “LOOK UP!” and an arrow image indicating the upper display panel 33 in the lower panel 16 based on the stop control game effect instruction signal as shown in FIG. 11. By the processing in steps S34-S35, it is possible for a player to recognize that the stop control game is being executed. Further, it is possible for the slot machine 10 to prompt the player to cause “LOBSTER” to stop in the middle tier of the display window 155.

In step S36, the main CPU 41 determines the condition that the stop switch 82 is pressed, specifically, the condition that a control input signal from the stop switch 82 is received, and proceeds to step S38 when the condition is met and proceeds to step S37 when the condition is not met.

In step S37, the main CPU 41 determines the condition that a predetermined time (for example, 10 seconds) elapses after the processing in step S35 is completed and proceeds to step S38 when the condition is met and returns to step S36 when the condition is not met.

In step S38, the main CPU 41 outputs the final stop instruction signal to cause the symbols to stop in the display window 155 to the graphic board 68. By the way, in the case of “YES” in step S36, the main CPU 41 outputs the final stop instruction signal with the timing when the control input signal is received and in the case of “YES” in step S37, outputs the final stop instruction signal with the timing when the condition in step S37 is met. The graphic board 68 controls the lower display panel 16 based on the final stop instruction signal. It is determined whether the condition that “LOBSTER” is currently positioned in the middle or upper tier of the display window 155 is met or not by the control of the graphic board 68. When the condition is met, “LOBSTER” comes to a stop in the middle tier of the display window 155 as shown in FIG. 10B or, when the condition is not met, a symbol other than “LOBSTER” (in FIG. 10C, “STRAWBERRY”) comes to a stop in the middle tier of the display window 155 as shown in FIG. 10C. The symbols stop in the display windows 151-155, thereby the stop control unit game is over.

In step S39, the main CPU 41 determines the condition that the specific combination (that is, five “LOBSTER” s) has stopped on the payline L and proceeds to step S40 when the condition is met and proceeds to step S45 when the condition is not met.

In step S40, the main CPU 41 increments the number “m” of times of success in stop by “1”.

In step S41, the main CPU 41 determines the condition that the number “m” of times of success in stop is equal to or greater than “5” and proceeds to step S42 when the condition is met and proceeds to step S48 when the condition is not met.

In step S42, the main CPU 41 determines the condition that the number of credits for jackpot is equal to or greater than a predetermined jackpot threshold value and proceeds to step S43 when the condition is met and proceeds to step S48 when the condition is not met.

In step S43, the main CPU 41 determines whether or not to pay out coins in accordance with the number of credits for jackpot. Specifically, the main CPU 41 generates one random number in the range of 0 to 65535 and determines the condition that the generated random number is included in a predetermined jackpot winning range (for example, a range of 150 to 151). When the condition is met, as a result, the main CPU 41 determines to pay out coins in accordance with the number of credits for jackpot and when the condition is not met, the main CPU 41 determines not to pay out coins in accordance with the number of credits for jackpot. When determining to pay out coins in accordance with the number of credits for jackpot, the main CPU 41 proceeds to step s44 and proceeds to step S48 when determining not to pay out coins in accordance with the number of credits for jackpot.

In step S44, the main CPU 41 pays out coins in accordance with the number of credits for jackpot (specifically, increments the total number of credits by the number of credits for jackpot). Then, the main CPU 41 resets the number of credits for jackpot to “0” and ends the stop control game execution processing.

In step S45, the main CPU 41 resets the number “m” of times of success in stop to “0”.

In step S46, the main CPU 41 determines the condition that the number “n” of times of failure in stop is “5” and proceeds to step S48 when the condition is met and proceeds to step S47 when the condition is not met.

In step S47, the main CPU 41 increments the number “n” of times of failure in stop by “1”. According to step S39, step S46, and step S47, the number “n” of times of failure in stop indicates the number of times of the stop control unit game in which a specific combination did not stop on the payline L (hereinafter, also referred to as “stop operation failure game”). Further, the upper limit value of the number “n” of times of failure in stop is set to “5”, as a result. However, the upper limit value of the number “n” of times of failure in stop is not limited to “5”.

In step S48, the main CPU 41 increments the number “r” of times of execution of the stop control unit game by “1”.

In step S49, the main CPU 41 determines the condition that the number “r” of times of execution of the stop control unit game is “10” and proceeds to step S50 when the condition is met and returns to step S32 when the condition is not met. According to the processing in step S32 to step S49, the main CPU 41 executes the stop control unit game 10 times.

According to the processing in step S39 to step S49, the main CPU 41 determines whether or not to pay out coins in accordance with the number of credits for jackpot only when a specific combination stops on the payline L five or more times successively and the number of credits for jackpot becomes equal to or greater than the jackpot threshold value.

In step S50, the main CPU 41 determines the stock rate based on the number “n” of times of failure in stop and the following expression (1). In the following expressions (1) to (3), Y1 is the number of coins to be paid out to a player, Y2 is a value to be added to the number of credits for jackpot, and Z1 is the stock rate.

Z1=3+5*n (1)

For example, when the number “n” of times of failure in stop is “3”, the stock rate is determined to be 18%. The stock rate is determined to be 3% at minimum.

The main CPU 41 calculates a value to be added to the number of credits for jackpot based on the determined stock rate and the following expression (2) (decimal fraction is rounded off).

Y2=30*Z1/100 (2)

The main CPU 41 adds the calculated value to the number of credits for jackpot. Due to this, the main CPU 41 stores coins cumulatively. The main CPU 41 determines the number of coins to be paid out to a player based on the calculated value and the following expression (3).

Y1=30−Y2 (3)

The main CPU 41 increments the total number of credits by the determined number. Due to this, the main CPU 41 pays out coins in the determined number. Then, the main CPU 41 ends the stop control game execution processing.

According to expressions (1) to (3), the greater the number of stop operation failure games is, the more the main CPU 41 reduces the number of coins to be paid out to a player and increases the stock rate. In other words, the main CPU 41 increments or decrements the number of coins to be paid out to a player according to the number of stop operation failure games and varies the stock rate.

By the way, the stock rate and expressions (1) to (3) in the present embodiment are just examples and arbitrary modifications are possible in the range not deviating from the concept of the present invention. For example, expression (1) may be modified into the following expression (1-1).

Z1=5*n (1-1)

In this case, if a specific combination stops on the payline L in all of the ten stop control unit games, the stock rate becomes “0”, therefore, the main CPU 41 substantially determines whether or not to store coins for jackpot according to whether or not a specific combination stops on the payline L 10 times successively.

According to the processing in step S14 to step S16, the main CPU 41 executes either of the base game in which plural symbols arranged on the display are automatically rearranged and the stop control game constituted by plural stop control unit games in which rearrangement of symbols is made possible when a control input signal is received from an external, and when executing the stop control game, increments or decrements the number of credits to be given to a player according to the number of times of the stop control unit game in which symbols were not rearranged in a specific combination and functions as a controller to vary the stock rate for the credit to be stored cumulatively in a predetermined number according to the number of times.

In the manner described above, the slot machine 10 varies the number of coins to be paid out to a player and the stock rate in accordance with the number of stop operation failure games. Therefore, it is possible for the slot machine 10 to have new gaming properties that the number of coins to be paid out to a player and the stock rate vary in accordance with the number of times of stop operation failure games and therefore to prevent a player from losing the zest and interest for the game. In other words, the slot machine 10 is equipped with new entertainment properties.

In particular, the greater the number of times of stop operation failure games, the greater the slot machine 10 increases the stock rate, therefore, the greater the number of times of stop operation failure games, the greater the number of credits for jackpot becomes. Accordingly, the greater the number of times of stop operation failure games, the greater the fun when coins in the number of credits for jackpot are paid out.

Further, in the slot machine 10, the greater the stock rate, the smaller the number of coins to be paid to a player becomes, therefore, it is possible for a player good at stop operation (that is, a player good at causing a specific combination to stop on the payline L) to maintain the number of coins to be paid out to the player at a rather high level by reducing the number of times of stop operation failure games. Further, it is possible for a player good at stop operation to intentionally increase the stock rate by intentionally increasing the number of times of stop operation failure games.

Furthermore, with the slot machine 10, it is possible to cause a player not good at stop operation (that is, a player not good at causing a specific combination to stop on the payline L) to have a stronger will to improve the technique to cause a specific combination to stop on the payline L than the case where the stock rate is constant irrespective of the number of times of stop operation failure games. In other words, with the slot machine 10, it is possible to cause a player not good at stop operation to have the zest and interest for the game continuously.

Still furthermore, with the slot machine 10, it is possible to prevent the stock rate from becoming great infinitely because the upper limit value of the stock rate is set. In particular, with the slot machine 10, the upper limit value is set to the stock rate, therefore, it is unlikely that the number of coins to be paid out to a player becomes smaller than a certain value no matter how great the number of times of stop operation failure games becomes. Accordingly, it is possible for a player not good at stop operation to enjoy playing the stop control game at ease.

The embodiments of the slot machine according to the present invention are explained as above, however, they are just examples and never limit the present invention and the specific configurations such as each unit etc. can be modified in design adequately. Further, the effects described in the embodiments of the present invention are just enumerated as most preferable effects brought about from the present invention and the effects of the present invention are not limited to those described in the embodiments of the present invention. For example, in the present embodiments, specific combinations are fixed, however, they may be changed for each stop control game. For example, in a stop control unit game, if a specific combination did not stop on the payline L, the specific combination may be changed in the next stop control unit game. In this case, it may also be possible to notify a player of a specific combination each time the specific combination is changed.

What is claimed is:

1. A slot machine comprising a controller operable to:
(a) execute either a base game in which plural symbols arranged on a display are rearranged automatically or a stop control game constituted by plural stop control unit games in which the symbols can be rearranged upon receipt of a control input signal from an external;
(b) increase or decrease the amount of credit to be given to a player in accordance with the number of times of stop control unit games in which the symbols were not rearranged in a specific combination when executing the stop control game; and
(c) vary a stock rate for the credit stored cumulatively in a predetermined amount in accordance with the number of times.

2. The slot machine according to claim 1,
wherein the controller is operable to increase the stock rate with increasing number of times of the stop control unit game in which the symbols were not rearranged in a specific combination.

3. The slot machine according to claim 2,
wherein the controller is operable to set an upper limit value of the stock rate.

4. A slot machine comprising a controller operable to:
(a) determine which one to execute between a base game in which plural symbols arranged on a display are rearranged automatically and a stop control game constituted by plural stop control unit games in which the symbols can be rearranged upon receipt of a control input signal from an external;
(b) execute the stop control unit game more than once when having determined to execute the stop control game;
(c) increase or decrease the amount of credit to be given to a player in accordance with the number of times of the stop control unit game in which the symbols were not rearranged in a specific combination; and
(d) vary a stock rate for the credit stored cumulatively in a predetermined amount in accordance with the number of times.

5. The slot machine according to claim 4,
wherein the controller is operable to increase the stock rate with increasing number of times of the stop control unit game in which the symbols were not rearranged in a specific combination.

6. The slot machine according to claim 5,
wherein the controller is operable to set an upper limit value of the stock rate.

7. A slot machine comprising:
a display for arranging a symbol matrix formed by plural columns and plural rows;
a stop switch that can be operated by a player and which outputs a control input signal in accordance with the operation of the player; and
a controller operable to:
(a) determine which one to execute between a base game in which plural symbols arranged on a display are rearranged automatically and a stop control game constituted by plural stop control unit games in which the symbols can be rearranged upon receipt of a control input signal from the stop switch;
(b) activate the stop switch and executes the stop control unit game more than once when having determined to execute the stop control game;
(c) increase or decrease the amount of credit to be given to the player in accordance with the number of times of the stop control unit game in which the symbols were not rearranged in a specific combination; and
(d) vary a stock rate for the credit stored cumulatively in a predetermined amount in accordance with the number of times.

8. The slot machine according to claim 7,
wherein the controller is operable to increase the stock rate with increasing number of times of the stop control unit game in which the symbols were not rearranged in a specific combination.

9. The slot machine according to claim 8,
wherein the controller is operable to set an upper limit value of the stock rate.

10. A playing method of a slot machine, comprising:
executing either a base game in which plural symbols arranged on a display are rearranged automatically or a stop control game constituted by plural stop control unit games in which the symbols can be rearranged upon receipt of a control input signal from an external; and
when the stop control game is executed, increasing or decreasing the amount of credit to be given to a player in accordance with the number of times of the stop control unit game in which the symbols were not rearranged in a specific combination and further varying a stock rate for the credit stored cumulatively in a predetermined amount in accordance with the number of times.

11. The playing method of a slot machine according to claim 10,
wherein the stock rate is increased with increasing number of times of the stop control unit game in which the symbols were not rearranged in a specific combination.

12. The playing method of a slot machine according to claim 11,
wherein an upper limit value of the stock rate is set.

13. A playing method of a slot machine, comprising:
determining which one to execute between a base game in which plural symbols arranged on a display are rearranged automatically and a stop control game constituted by plural stop control unit games in which the symbols can be rearranged upon receipt of a control input signal from an external;
executing the stop control unit game more than once when it is determined to execute the stop control game; and
increasing or decreasing the amount of credit to be given to a player in accordance with the number of times of the stop control unit game in which the symbols were not rearranged in a specific combination and further varying a stock rate for the credit stored cumulatively in a predetermined amount in accordance with the number of times.

14. The playing method of a slot machine according to claim 13,
wherein the stock rate is increased with increasing number of times of the stop control unit game in which the symbols were not rearranged in a specific combination.

15. The playing method of a slot machine according to claim 14,
wherein an upper limit value of the stock rate is set.

16. A playing method of a slot machine, comprising:
scrolling plural symbols arranged on a display;
determining which one to execute between a base game in which plural symbols arranged on the display are rearranged automatically and a stop control game constituted by plural stop control unit games in which the symbols can be rearranged upon receipt of a control input signal from a stop switch that can be operated by a player; and
when it is determined to execute the stop control game, activating the stop switch, executing the stop control unit game more than once, and increasing or decreasing the amount of credit to be given to the player in accordance with the number of times of the stop control unit game in which the symbols were not rearranged in a specific combination, and further varying a stock rate for the credit stored cumulatively in a predetermined amount in accordance with the number of times.

17. The playing method of a slot machine according to claim 16,
wherein the stock rate is increased with increasing number of times of the stop control unit game in which the symbols were not rearranged in a specific combination.

18. The playing method of a slot machine according to claim 17,
wherein an upper limit value of the stock rate is set.
